(19) United States
(12) Patent Application Publication
(10) Pub. No.: US 2023/0063252 A1
(43) Pub. Date: Mar. 2, 2023

(54) SOFT BOX SUPPORTING ROD CLAMPING SEAT

(71) Applicant: GUOYU QUE, Shenzhen (CN)

(72) Inventor: GUOYU QUE, Shenzhen (CN)

(21) Appl. No.: 17/460,221

(22) Filed: Aug. 29, 2021

(51) Int. Cl. G03B 15/06

(52) U.S. Cl. CPC G03B 15/06

(57) ABSTRACT

The present disclosure provides a soft box supporting rod clamping seat, wherein the soft box supporting rod clamping seat comprises a frame body, a lock latch, a spring, and a connector. The lock latch comprises a limit hook and a first rotating part rotationally connected to the frame body, and the lock latch is limited to rotate within a preset angle by the frame body. The spring comprises a first end connected to the frame body and a second end connected to the lock latch. The connector comprises a hook and a second rotating part rotationally connected to the frame body, and the connector is used for installing a supporting rod. The technical solution of the present disclosure effectively solves the problems in the prior that a soft box base is complex in structure assembly, and clamping and folding of supporting rods are time-consuming and labor-consuming.

### TECHNICAL FIELD

The utility model relates to the technical field of soft boxes, in particular to a soft box supporting rod clamping seat, a soft box base using the soft box supporting rod clamping seat, and a quick-assembled soft box.

### BACKGROUND

A soft box is photographic equipment consisting of reflective cloth, soft lighting cloth, supporting rods, a base, and the like. The soft box cannot be used independently and belongs to accessories of studio lamps. After the soft box is installed on a studio lamp, the emitted light is softer, and light spots and shadows on photos may be eliminated during shooting. Wherein a base structure of the soft box is an important component for achieving supporting and convenient folding of supporting rods and the reflective cloth, and thus the design and improvement of the base assembly are the key for improving the practicability of the soft box.

In the prior art, there are many types of bases for soft boxes, but most of them have some defects of inconvenience in unfolding and folding and the like. For example, in some hand-pressing buckle type soft box clamping seats, an assembly process is complex, operation and use are inconvenient, and a buckle structure is not firm and easy to release; and in some structures adopting hooks for clamping, the clamping and releasing of supporting rods may be achieved only through large force, and time and labor are wasted.

### SUMMARY

Embodiments of the present disclosure aim to provide a soft box supporting rod clamping seat to solve the problems in the prior art that a soft box supporting rod clamping seat is complex in structure assembly, and clamping and folding of a supporting rod are time-consuming and labor-consuming.

A second purpose of the embodiments of the present disclosure is further to provide a soft box base using the supporting rod clamping seat.

A third purpose of the embodiments of the present disclosure is further to provide a quick-assembled soft box using the soft box base.

In a first aspect, a soft box supporting rod clamping seat is provided, which comprises a frame body, a lock latch, a spring, and a connector. The lock latch comprises a limit hook and a first rotating part rotationally connected to the frame body, and the lock latch is limited to rotate within a preset angle by the frame body. The spring comprises a first end connected to the frame body and a second end connected to the lock latch, and the spring exerts an acting force to enable the frame body and the lock latch to be away from each other. The connector comprises a hook and a second rotating part rotationally connected to the frame body, and the connector is used for installing a supporting rod. Relative position states of the hook and the limit hook comprise a first state in which the hook and the limit hook are separated from each other, a second state in which the hook and the limit hook are in mutual contact motion, and a third state in which the hook and the limit hook are clamped with each other.

In one implementable embodiment, the lock latch comprises a toggle part connected to the first rotating part; and the frame body is provided with an opening which is matched with the toggle part and is used for limiting motion range of the toggle part.

In one implementable embodiment, the limit hook, the first rotating part and the toggle part of the lock latch are of an integrated structure, and the toggle part is located between the limit hook and the toggle part.

In one implementable embodiment, the opening comprises a left side and a right side, a preset rotating angle of the lock latch comprises a right limit angle and a left limit angle; when the toggle part is in contact with the right side of the opening, the lock latch is located at the right limit angle; and when the toggle part is in contact with the left side of the opening, the lock latch is located at the left limit angle.

In one implementable embodiment, the frame body of the clamping seat comprises a frame cover and a frame seat, the frame cover is provided with the opening, the frame seat is provided with necks matched with the first rotating part and the second rotating part, the frame cover is detachably connected with the frame seat, and the lock latch and the connector are limited in the frame seat by the frame cover.

In one implementable embodiment, the connector comprises an extension part for installing and fixing the supporting rod, and the extension part is formed by extending along the axis of the second rotating part in the perpendicular direction of the second rotating part, and the extension part is provided with the hook.

According to a second aspect of the present disclosure, a soft box base is provided, which comprises a speed ring adapter assembly and a speed ring. The speed ring adapter assembly comprises a plurality of soft box supporting rod clamping seats of the above technical solution, and the plurality of clamping seats are connected with one another. One end of the speed ring is connected to the speed ring adapter assembly in a matched manner, and the other end of the speed ring is matched with a light source, and the middle of the speed ring is used for allowing the light source to pass through.

In one implementable embodiment, the speed ring adapter assembly comprises a speed ring adapter cover and a speed ring adapter seat which are detachably connected in a matched manner. The speed ring adapter cover is a ring-shaped cover formed by sequentially connecting frame covers of the plurality of clamping seats, and the speed ring adapter seat is a ring-shaped seat formed by sequentially connecting frame seats of the plurality of clamping seats. Or, the speed ring adapter cover is an integrally formed ring-shaped cover formed by sequentially connecting the frame covers of the plurality of clamping seats, and the speed ring adapter seat is an integrally formed ring-shaped seat formed by sequentially connecting the frame seats of the plurality of clamping seats.

In one implementable embodiment, a retractable structure is included, a plurality of lock latches are serially connected together by the retractable structure, and the retractable structure is used for driving the plurality of lock latches to rotate simultaneously.

According to a third aspect of the present disclosure, a quick-assembled soft box is also provided, which comprises a soft box base of the above technical solution.

The present embodiment has the beneficial effects that:

(1) by applying the technical solution of the present disclosure, when a device is assembled, a first rotating part of a lock latch and a second rotating part of a connector are installed at corresponding positions of a frame body respectively, and then a spring is installed between the lock latch and the frame body to connect the lock latch and the frame body together. The whole assembly process is simple and easy to operate, has no need of high precision, and is particularly clear in assembly position.

(2) When the device is used, firstly, in a folding state, relative position states of a hook and a limit hook are in a first state in which the hook and the limit hook are separated from each other, that is, the hook and the limit hook are neither in contact nor in clamping. Secondly, in a middle state, the connector is operated to be lifted up to rotate around the second rotating part of the connector, thereby making the hook and the limit hook be in contact with each other, and at the moment, the hook and the limit hook are not clamped together but are in contact with each other; when the hook of the connector moves and is in contact with the limit hook, the limit hook moves to drive the lock latch to rotate around the first rotating part of the lock latch, then the spring is compressed to make the hook further move to a position where the hook is clamped with the limit hook, and at the moment, the relative positions of the hook and the limit hook are in a second state in which the hook and the limit hook are in mutual contact motion. Then, in a clamping state, the hook is further rotated to move to a final position, the hook no longer abuts against the limit hook, and since the elastic force of the spring makes the lock latch rotate in an opposite direction, the limit hook is firmly clamped with the hook, and at the moment, the relative positions of the hook and the limit hook are in a third state in which the hook and the limit hook are clamped with one another. Finally, the device is returned to the folding state again after the use is finished, at the moment, the lock latch can rotate to compress the spring only by toggling the lock latch, and then the limit hook is separated from the hook, and the limit hook and the hook enter the second state of mutual contact again and finally return to the first state of mutual separation to complete the folding.

Through the use process, the whole process from clamping of the connector and the lock latch to separation of the connector and the lock latch for folding may be summarized as follows: the connector may be clamped with the lock latch by rotating the connector, the connector can be folded by rotating the lock latch, and then a supporting rod connected to the connector is folded, and thus the whole operation process is extremely simple and convenient, and time-saving and labor-saving.

The technical solution of the present disclosure effectively solves the problems in the prior art that a soft box base is complex in structure assemble, and clamping and folding of supporting rods are time-consuming and labor-consuming.

### BRIEF DESCRIPTION OF THE DRAWINGS

The accompanying drawings, which form a part of the present disclosure, are used to provide a further understanding of the present disclosure, and illustrative embodiments of the present disclosure and descriptions thereof are used to explain the present disclosure and are not to be construed as an undue limitation of the present disclosure. In the drawings:

FIG. 1 illustrates a schematic diagram of a soft box base according to an embodiment of the present disclosure;

FIG. 2 illustrates a schematic diagram of explosion of a soft box base in FIG. 1;

FIG. 3 illustrates a cross-sectional diagram of a soft box base of FIG. 1 in a clamping state;

FIG. 4 illustrates a cross-sectional diagram of a soft box base of FIG. 1 in a folding state;

FIG. 5 illustrates an enlarged schematic view of a clamping state at A in FIG. 3;

FIG. 6 illustrates an enlarged view of mutual contact motion of a limit hook and a hook;

FIG. 7 illustrates an enlarged schematic view of a folding state at B in FIG. 3;

FIG. 8 illustrates a schematic diagram of a limit hook, a spring, and a hook;

FIG. 9 illustrates a diagram of a first retractable structure;

FIG. 10 illustrates a diagram of a second retractable structure;

FIG. 11 illustrates a diagram of a third retractable structure;

FIG. 12 illustrates a diagram of a fourth retractable structure;

FIG. 13 illustrates a diagram of a spring-back structure used by retractable structures in FIG. 11 and FIG. 12.

Wherein the above accompanying drawings comprise the following reference numerals:

10—frame body; 11—opening; 12—frame cover; 13—frame seat; 20—lock latch; 21—limit hook; 22—first rotating part; 23—toggle part; 30—spring; 40—connector; 41—hook; 42—second rotating part; 43—extension part; 50—supporting rod; 100—speed ring adapter assembly; 110—speed ring adapter cover; 130—speed ring adapter seat; 200—speed ring; 300—retractable structure; 301—tandem rod; 302—handle; 303—press piece; 304—spring-back piece.

### DESCRIPTION OF THE EMBODIMENTS

To make purposes, technical solutions, and advantages of the embodiments of the present disclosure clearer, the technical solutions in the embodiments of the present disclosure will be clearly and fully described below in conjunction with the accompanying drawings in the embodiments of the present disclosure. Apparently, the described embodiments are a part rather than all embodiments of the present disclosure. The assemblies of the embodiments of the present disclosure, as generally described and illustrated in the accompanying drawings herein, may be arranged and designed in a wide variety of different configurations.

Thus, the following detailed description of the embodiments of the present disclosure provided in the accompanying drawings is not intended to limit the scope of the present disclosure claimed for protection, but is merely representative of selected embodiments of the present disclosure. Based on the embodiments in the present disclosure, all other embodiments obtained by those of ordinary skill in the art without creative efforts shall fall within the scope of protection of the present disclosure.

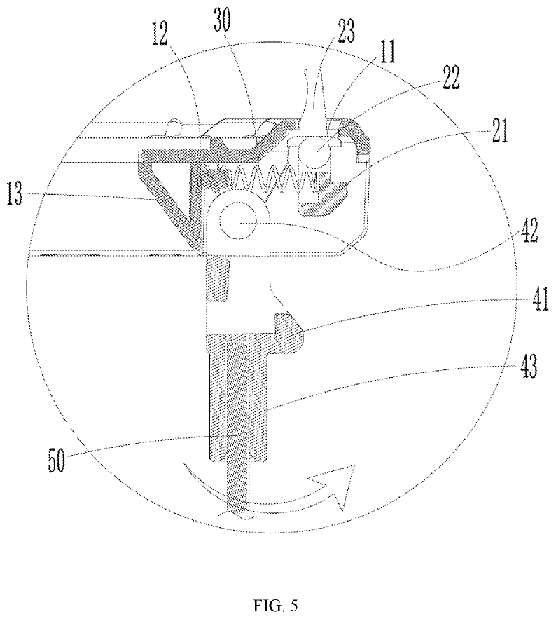

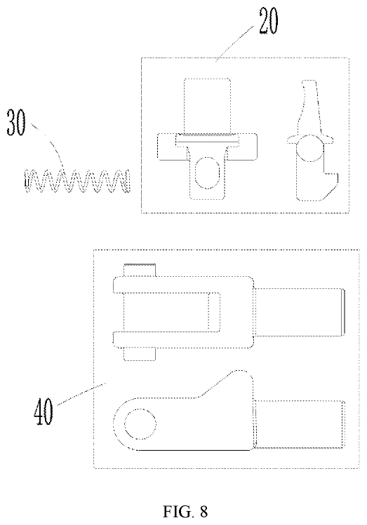

According to a first aspect of the present disclosure, a soft box support rod clamping seat is provided at first. Referring to FIG. 5 to FIG. 8, a soft box support clamping seat comprises a frame body 10, a lock latch 20, a spring 30, and a connector 40.

The lock latch 20 comprises a limit hook 21 and a first rotating part 22 rotationally connected to the frame body 10, and the lock latch 20 is limited to rotate in a preset angle by the frame body 10. The spring 30 comprises a first end connected to the frame body 10 and a second end connected to the lock latch 20, and the spring 30 exerts an acting force to enable the frame body 10 and the lock latch 20 to be away from each other. The connector 40 comprises a hook 41 and a second rotating part 42 rotationally connected to the frame body 10, and the connector 40 is used for installing a supporting rod 50. Relative position states of the hook 41 and the limit hook 21 comprise a first state in which the hook 41 and the limit hook 21 are separated from each other, a second state in which the hook 41 and the limit hook 21 are in mutual contact motion, and a third state in which the hook 41 and the limit hook are clamped with each other.

By applying the technical solutions of the embodiments, when a device is assembled, the first rotating part 22 of the lock latch 20 and the second rotating part 42 of the connector 40 are installed at corresponding positions of the frame body 10 respectively, and then the spring 30 is installed between the lock latch 20 and the frame body 10 to connect the lock latch 20 and the frame body 10 together. The whole assembly process is simple and easy to operate, has no need of high precision, and is particularly clear in assembly position.

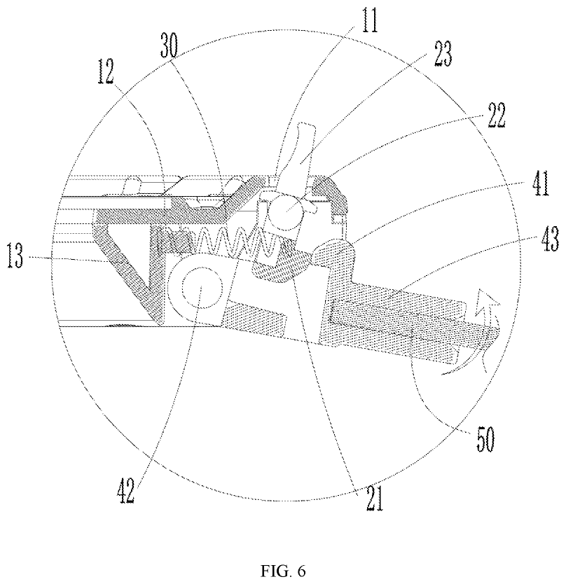

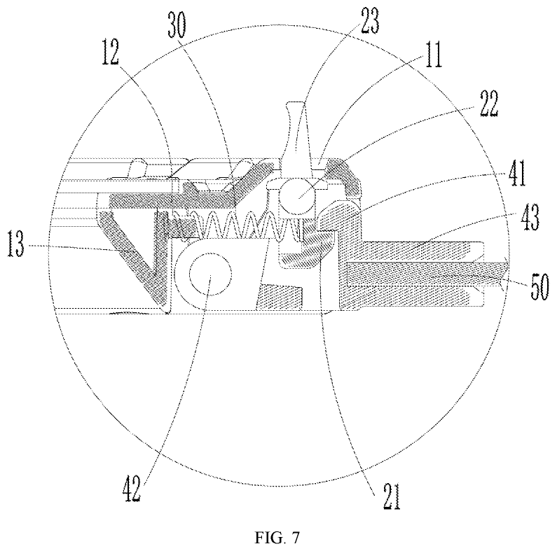

Further, when the device is used, firstly, in a folding state as shown in FIG. 5, the relative position states of the hook 41 and the limit hook 21 are in the first state in which the hook 41 and the limit hook 21 are separated from each other, that is, the hook 41 and the limit hook 21 are neither in contact nor in clamping. Secondly, in a middle state as shown in FIG. 6, the connector 40 is operated to be lifted up to rotate around the second rotating part 42 of the connector 40, thereby making the hook 41 and the limit hook 21 be in contact with each other, and at the moment, the hook 41 and the limit hook 21 are not in clamping but are in contact with each other; when the hook 41 of the connector 40 moves and is in contact with the limit hook 21, the limit hook 21 moves to drive the lock latch 20 to rotate around the first rotating part 22 of the lock latch 20, then the spring 30 is compressed to make the hook 41 further move to a position where the hook 41 is clamped with the limit hook 21, and at the moment, the relative positions of the hook 41 and the limit hook 21 are in the second state in which the hook 41 and the limit hook 21 are in mutual contact motion. Then, in a clamping state as shown in FIG. 7, the hook 41 is further rotated to move to a final position, the hook 41 no longer abuts against the limit hook 21, and since the elastic force of the spring 30 makes the lock latch 20 rotate in an opposite direction, the limit hook 21 is firmly clamped with the hook 41, and at the moment, the relative positions of the hook 41 and the limit hook 21 are in a third state in which the hook 41 and the limit hook 21 are clamped with each other. Finally, the device is returned to the folding state again as shown in FIG. 5 after the use is finished, at the moment, the lock latch 20 is rotated to compress the spring 30 only by toggling the lock latch 20, and then the limit hook 21 is separated from the hook 41, and the limit hook 21 and the hook 41 enter the second state of mutual contact again and finally return to the first state of mutual separation to complete the folding. Through the use process, the whole process from clamping of the connector 40 and the lock latch 20 to separation of the connector 40 and the lock latch 20 for folding may be summarized as follows: the connector 40 may be clamped with the lock latch 20 by rotating the connector 40, the connector 40 may be folded by rotating the lock latch 20, and then the supporting rod 50 connected to the connector 40 is folded, and thus the whole operation process is extremely simple and convenient, and time-saving and labor-saving. The technical solutions of the embodiments effectively solve the problems in the prior art that a soft box base is complex in structure assembly, and clamping and folding of supporting rods are time-consuming and labor-consuming.

In the technical solution of the embodiment, as shown in FIG. 5 to FIG. 8, the lock latch 20 comprises the toggle part 23 connected to the first rotating part 22, and a frame body 10 is provided with an opening 11 which is matched with the toggle part 23 and is used for limiting a motion range of the toggle part 23. The toggle part 23 stretches out field the opening 11 of the frame body 10, the size of the opening 11 forms limitation on a toggle range of the toggle part 23, and rotation of the lock latch 20 around the first rotating part 22 of the lock latch 20 may be achieved through the toggle part 23 in an extremely convenient manner, thereby releasing a clamping state during folding conveniently.

In the technical solution of the embodiment, as shown in FIG. 5 to FIG. 8, the limit hook 21, the first rotating part 22 and the toggle part 23 of the lock latch 20 are of an integrated structure, and the toggle part 23 is located between the limit hook 21 and the toggle part 23. The lock latch 20 is a small lever structure, the first rotating part 22 is a fulcrum, the toggle part 23 is a force exerting end, and the limit hook 21 acts with the action of the toggle part 23.

It is to be noted that the frame body 10 is provided with a groove or a bulge structure for connection with a spring 30 to prevent the connection between the frame body 10 and the spring 30 from falling off. The limit hook 21 of the lock latch 20 is a matching section, the limit hook is arranged on one side of the matching section, and a groove or bulge structure is arranged on the other side of the matching section and is used for connection with the spring 30 to prevent the connection between the lock latch 20 and the spring 30 from falling off in the rotating action of the lock latch 20. The length of the toggle part 23 is longer than the distance from a connecting position of the spring 30 and the lock latch 20 to the first rotating part 22 as much as possible, and therefore the labor is saved when rotation of one side of the limit hook 21 is achieved by moving the toggle part 23.

In the technical solution of the embodiment, as shown in FIG. 5 to FIG. 8, the opening 11 comprises a right side and a left side, a preset rotating angle of the lock latch 20 comprises a right limit angle and a left limit angle; when the toggle part 23 is in contact with the right side of the opening 11, the lock latch 20 is located at the right limit angle; and when the toggle part 23 is in contact with the left side of the opening 11, the lock latch 20 is located at the left limit angle. In the process of unfolding the supporting rod 50, namely, from separation to clamping of the limit hook 21 and the hook 41, the toggle part 23 is driven by the limit hook 21 to firstly move towards the right side of the opening 11 and then move towards the left side to make the limit hook 21 clamp with and the hook 41. In the process of folding the supporting rod 50, namely, from clamping to separation of the limit hook 21 and the hook 41, the toggle part 23 is operated to move towards the right side and then make the limit hook 21 move towards the left side, thereby making the limit hook 21 and the hook 41 be separated from the clamping state. The left and right sides or the left and right limit angles limit a motion angle of the toggle part 23, which makes the operation of the lock latch 20 more concise. Meanwhile, a character or graphic mark may be arranged on the outer side of the frame body 10 of the toggle part 23 to identify relationships between a toggle direction of the toggle part 23 and the clamping and between the toggle direction of the toggle part 23 and the folding.

In the technical solution of the embodiment, as shown in FIG. 5 to FIG. 8, the frame body 10 of the clamping seat comprises a frame cover 12 and a frame seat 13, the frame cover 12 is provided with an opening 11, the frame seat 13 is provided with necks matched with the first rotating part 22 and the second rotating part 42, the frame cover 12 is detachably connected with the frame seat 13, and the lock latch 20 and the connector 40 are limited in the frame seat 13 by the frame cover 12. Due to a detachable structure, the frame body 10 is convenient to assemble, and later parts replacement and maintenance are facilitated.

In the technical solution of the embodiment, as shown in FIG. 5 to FIG. 8, the connector 40 comprises an extension part 43 for installing and fixing a supporting rod 50, the extension part 43 is formed by extending along the axis of the second rotating part 41 in a perpendicular direction of the second rotating part 42, and the extension part 43 is provided with a hook 41. The extension part 43 and the hook 41 are integrated to play a role of fixing the supporting rod 50 and facilitate the rotating operation of the connector 40.

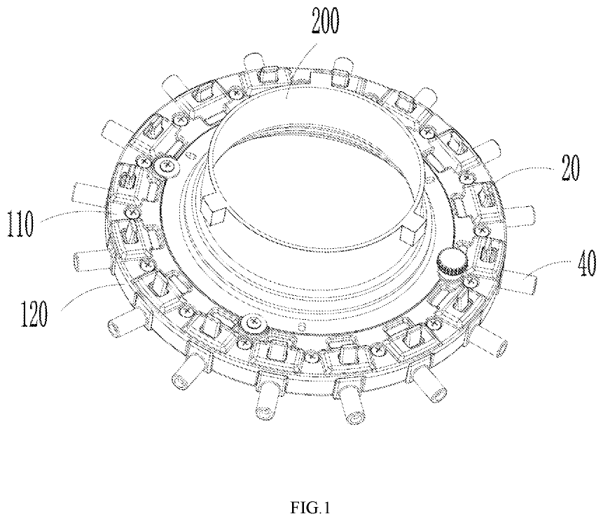

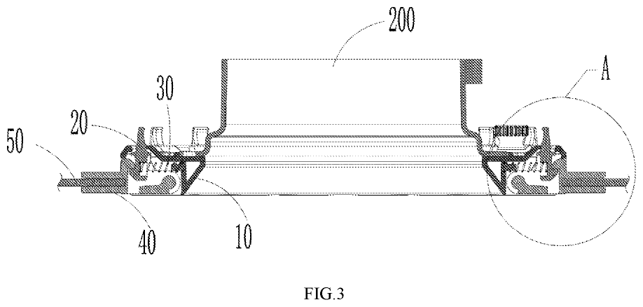

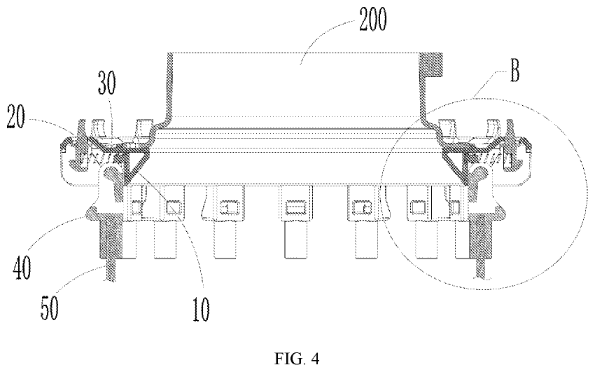

According to a second aspect of the present disclosure, as shown in FIG. 1 to FIG. 4, a soft box base is also provided, which comprises a speed ring adapter assembly 100 and a speed ring 200. The speed ring adapter assembly 100 comprises a plurality of clamping seats in the above technical solution, and the plurality of clamping seats may be circumferentially distributed, and the adjacent clamping seats are connected with each other. One end of the speed ring 200 is connected to the speed ring adapter assembly 100 in a matched manner, and the other end of the speed ring 200 is matched with a light source, and the middle of the speed ring 200 is used for allowing the light source to pass through.

It is to be noted that the soft box clamping seat according to the first aspect of the present disclosure may achieve the unfolding and folding of the single supporting rod 50, and a soft box base according to the second aspect of the present disclosure may achieve unfolding and folding of a plurality of supporting rods 50 easily through a combined device formed by a plurality of clamping seats, thereby achieving unfolding and folding of reflective cloth of the soft box easily.

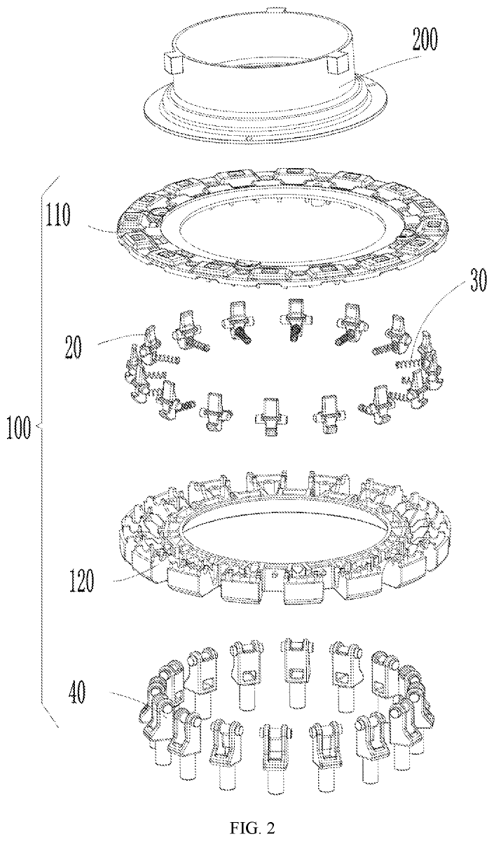

In the technical solution of the embodiment, as shown in FIG. 2, the speed ring adapter assembly 100 comprises a speed ring adapter cover 110 and a speed ring adapter seat 120 which are detachably connected in a matched manner. The later parts replacement and maintenance are facilitated.

Further, the speed ring adapter cover 110 is a ring-shaped cover formed by sequentially connecting frame covers 12 of a plurality of clamping seats, and the speed ring adapter seat 120 is a ring-shaped seat formed by sequentially connecting frame seats 13 of the plurality of clamping seats. Such structure may form a ring-shaped structure through the matching of the plurality of clamping seats, and after a certain clamping seat is damaged, a single clamping seat may be replaced without replacing the whole base, and thus the maintenance cost is saved.

Meanwhile, another technical solution may be employed, that is, the speed ring adapter cover 110 is an integrally formed ring-shaped cover formed by sequentially connecting the frame covers 12 of the plurality of clamping seats, and the speed ring adapter seat 120 is an integrally formed ring-shaped seat formed by sequentially connecting the frame seats 13 of the plurality of clamping seats. The adoption of an integrated structure has the advantages of less parts and simple assembly.

It is to be noted that the speed ring adapter cover 100 and the speed ring adapter seat 120 may also be square, triangular, and other ring-shaped structures with hollow middles, thereby adapting to soft boxes with different opening shapes. Correspondingly, the shape of the speed ring 200 is adapted to the shape of the speed ring adapter cover 110.

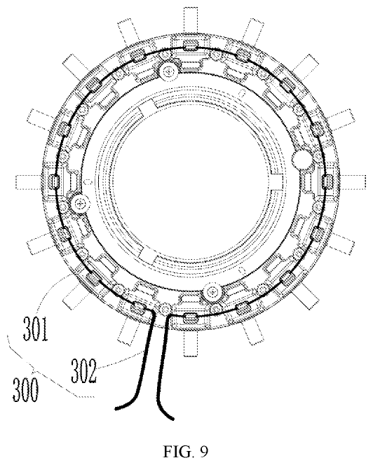

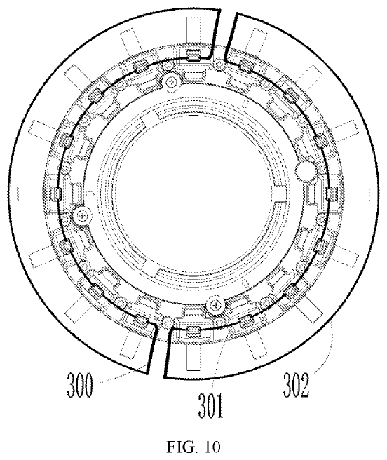

In the technical solution of the embodiment, as shown in FIG. 9 to FIG. 10, the soft box base may also comprise a retractable structure 300, toggle parts 23 of a plurality of lock latches 20 are connected in series through the retractable structure 300, and the retractable structure 300 is used for driving the plurality of lock latches 20 to rotate simultaneously. It is to be noted that there may be one or more retractable structures 300, and each retractable structure 300 is responsible for driving at least two or more lock latches 20 to rotate simultaneously.

Rotation of the plurality of lock latches 20 may be conveniently achieved through the retractable structure 300, thereby achieving quick folding action of the plurality of supporting rods 50 in a time-saving and labor-saving manner. An appearance of the retractable structure 300 is related to distributed positions of the plurality of toggle parts 23, and may be circular, elliptic, square, triangular, and the like.

In the technical solution of one embodiment, as shown in FIG. 9, the retractable structure 300 comprises a tandem rod 301 and a handle 302. The tandem rod 301 is used for connecting the plurality of toggle parts 23 in series, end parts of both ends of the tandem rod 301 extend a distance to form two handles 302, contraction or expansion of the tandem rod is achieved by making the two handles 302 close to or far away from each other, thereby achieving rotation of the toggle parts 23 in different directions, and achieving rotation of the lock latches 20 in different directions.

In the technical solution of one embodiment, as shown in FIG. 10, the retractable structure 300 comprises a plurality of tandem rods 301, each tandem rod 301 is provided with an operating handle 302, the plurality of tandem rods 301 are used for connecting a plurality of toggle parts 23 in series respectively, and lock latches 20 which are divided into multiple groups are respectively rotated by moving the plurality of tandem rods 301.

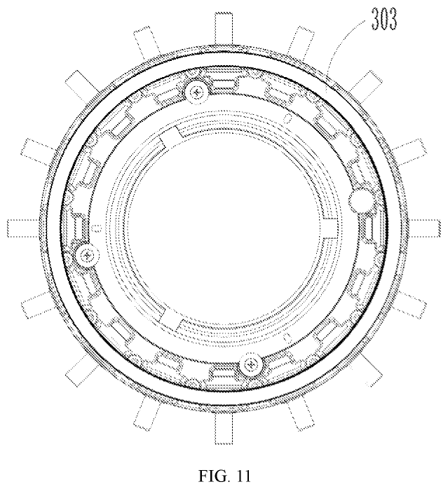

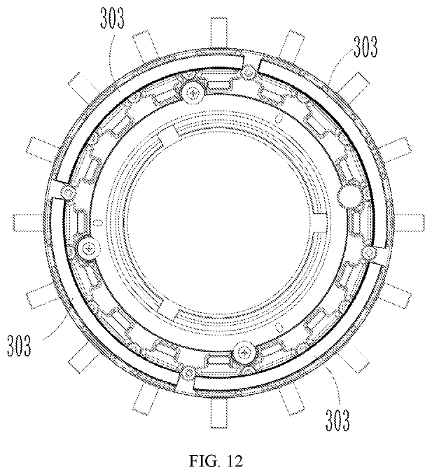

In the technical solution of one embodiment, as shown in FIG. 11 to FIG. 12, the retractable structure comprises one or more press pieces 303.

When only one press piece 303 is used, the press piece 303 may be a ring-shaped structure, the lower part of the ring-shaped structure is provided with a plurality of spring-back pieces 304, when the press piece 303 is pressed downwards, the rotation towards the outer side of all the lock latches 30 may be achieved, and thus a plurality of limit hooks 21 are separated from the hooks 41, and all connectors 40 may be folded.

When a plurality of press pieces 303 are used, the arrangement of the press pieces 303 are adapted to the arrangement of the toggle parts 23 of the lock latches 20, the press pieces 303 may be in contact with the plurality of toggle parts 23, the lower parts of the plurality of press pieces 303 are provided with a plurality of spring-back pieces 304 respectively, and the folding of a plurality of connector 40 which are divided into multiple groups are achieved in batches by sequentially pressing the plurality of press pieces 303 respectively.

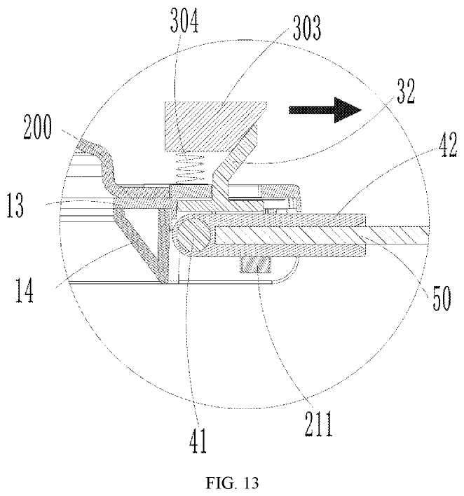

It is to be noted that as shown in FIG. 13, a structure at a contact position of the press piece 303 and the toggle part 23 may be an inclined surface, a cambered surface, and the like, and the press piece 303 is pressed downwards to be in contact with the toggle part 23, thereby pushing the toggle part 23 to rotate towards the outer side, the outward rotation of the lock latch 20 is achieved, and thus the limit hook 21 is separated from the hook 41, and the connector 40 may be folded.

It is to be noted that the form of the retractable structure 300 is not limited to the above types, and the structure capable of simultaneously driving two or more lock latches 20 to move simultaneously should fall within scope of protection of the present disclosure.

According to a third aspect of the present disclosure, a quick-assembled soft box is also provided, which comprises the soft box base in the above technical solution. The soft box using the above soft box base has the advantages of both the supporting rod clamping seat and the soft box base.

The above description is only the preferred embodiments of the present disclosure and is not intended to limit the present disclosure; and for those skilled in the art, the present disclosure may be modified and changed variously. All modifications, equivalent replacements, and improvements, which are made within the spirit and principle of the present disclosure, should be comprised in scope of protection of the present disclosure.

What is claimed is:

1. A soft box supporting rod clamping seat, comprising:
a frame body (10);
a lock latch (20), which comprises a limit hook (21) and a first rotating part (22) rotationally connected to the frame body (10), wherein the lock latch (20) is limited to rotate within a preset angle by the frame body (10);
a spring (30), which comprises a first end connected to the frame body (10) and a second end connected to the lock latch (20), wherein the spring (30) exerts an acting force to enable the frame body (10) and the lock latch (20) to be away from each other;
a connector (40), which comprises a hook (41) and a second rotating part (42) rotationally connected to the frame body (10), wherein the connector (40) is used for installing a supporting rod (50);
and relative position states of the hook (41) and the limit hook (21) comprise a first state in which the hook (41) and the limit hook (21) are separated from each other, a second state in which the hook (41) and the limit hook (21) are in mutual contact motion, and a third state in which the hook (41) and the limit hook (21) are clamped with each other.

2. The soft box supporting rod clamping seat according to claim 1, wherein the lock latch (20) comprises a toggle part (23) connected to the first rotating part (22); and the frame body (10) is provided with an opening (11) which is matched with the toggle part (23) and is used for limiting motion range of the toggle part (23).

3. The soft box supporting rod clamping seat according to claim 2, wherein the limit hook (21), the first rotating part (22) and the toggle part (23) of the lock latch (20) are of an integrated structure, and the toggle part (23) is located between the limit hook (21) and the toggle part (23).

4. The soft box supporting rod clamping seat according to claim 3, wherein the opening (11) comprises a left side and a right side, the preset rotating angle of the lock latch (20) comprises a right limit angle and a left limit angle; when the toggle part (23) is in contact with the right side of the opening (11), the lock latch (20) is located at the right limit angle; and when the toggle part (23) is in contact with the left side of the opening (11), the lock latch (20) is located at the left limit angle.

5. The soft box supporting rod clamping seat according to claim 4, wherein the frame body (10) of the clamping seat comprises a frame cover (12) and a frame seat (13), the frame cover (12) is provided with the opening (11), the frame seat (13) is provided with necks matched with the first rotating part (22) and the second rotating part (42), the frame cover (42) is detachably connected with the frame seat (3), and the lock latch (20) and the connector (40) are limited in the frame seat (13) by the frame cover (12).

6. The soft box supporting rod clamping seat according to claim 5, wherein the connector (40) comprises an extension part (43) for installing and fixing the supporting rod (50), and the extension part (43) is formed by extending along the axis of the second rotating part (42) in the perpendicular direction of the second rotating part (42), and the extension part (43) is provided with the hook (41).

7. A soft box base, comprising:
a speed ring adapter assembly (100), which comprises a plurality of soft box supporting rod clamping seats of claim 1, wherein the plurality of clamping seats are connected with one other;
and a speed ring, wherein one end of the speed ring is connected to the speed ring adapter assembly (100) in a matched manner, the other end of the speed ring (200) is matched with a light source, and the middle of the speed ring (200) is used for allowing the light source to pass through.

8. The soft box base according to claim 7, wherein the speed ring adapter assembly (100) comprises a speed ring adapter cover (110) and a speed ring adapter seat (120), and the speed ring adapter cover (110) is detachably connected with the speed ring adapter seat (120) in a matched manner;
the speed ring adapter cover (110) is a ring-shaped cover formed by sequentially connecting frame covers (12) of the plurality of clamping seats, and the speed ring adapter seat (120) is a ring-shaped seat formed by sequentially connecting frame seats (13) of the plurality of clamping seats; or
the speed ring adapter cover (110) is an integrally formed ring-shaped cover formed by sequentially connecting the frame covers (12) of the plurality of clamping seats, and the speed ring adapter seat (120) is an integrally formed ring-shaped seat formed by sequentially connecting the frame seats (13) of the plurality of clamping seats.

9. The soft box base according to claim 8, comprising a retractable structure (300), wherein a plurality of lock latches (20) are serially connected together by the retractable structure (300), and the retractable structure (300) is used for driving the plurality of lock latches (20) to rotate simultaneously.

10. A quick-assembled soft box, wherein the soft box base according to claim 9.
